(19) United States
(12) Patent Application Publication
(10) Pub. No.: US 2013/0335912 A1
(43) Pub. Date: Dec. 19, 2013

(54) MOUNTING APPARATUS FOR HARD DISK DRIVE

(71) Applicants: YU HAN, Shenzhen City (CN); JUN-HUI WANG, Shenzhen City (CN)

(72) Inventors: YU HAN, Shenzhen City (CN); JUN-HUI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/552,648

(22) Filed: Jul. 19, 2012

(30) Foreign Application Priority Data
Jun. 19, 2012 (CN) 2012102027349

(51) Int. Cl. G06F 1/16

(52) U.S. Cl. 361/679.33

(57) ABSTRACT

An apparatus for mounting a hard disk drive (HDD) includes a base board and a casing for receiving the HDD. A number of engaging portions and a holding portion protrude from the base board. The holding portion defines a through hole. The casing includes a bottom wall defining a number of fixing holes and a front wall perpendicular to the bottom wall. Each fixing hole includes a first hole and a second hole communicating with the first hole. A width of the first hole is greater than a width of the second hole. A fixing member is mounted on an outer surface of the front wall. The engaging portions extend through the first holes, respectively. The casing is then slid toward the holding portion, until the fixing member engages in the through hole and the engaging portions engage in the corresponding second holes.

### BACKGROUND

1. Technical Field

The present disclosure relates to an apparatus for mounting a hard disk drive (HDD).

2. Description of Related Art

Electronic devices, such as computers, are generally equipped with a data storage device, such as an HDD. Mounting the storage device to the electronic device by screws is inefficient and requires a tool, such as a screw driver, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a mounting apparatus having a fixing member, together with a hard disk drive.

FIG. 2 is a cross-sectional view of the fixing member of FIG. 1, taken along the line II-II.

FIG. 3 is a partly assembled, isometric view of FIG. 1.

FIG. 4 is a partly cross-sectional view of FIG. 3, taken along the line IV-IV.

FIG. 5 is an assembled, isometric view of FIG. 1.

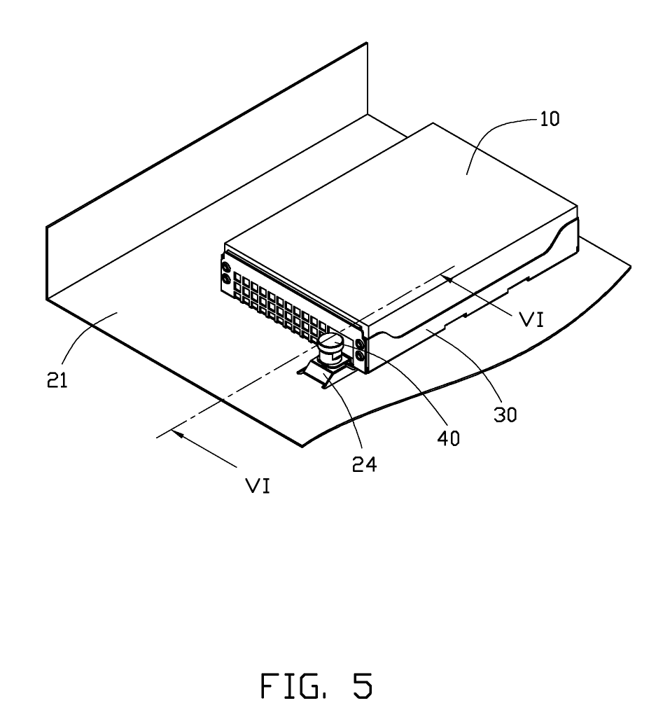

FIG. 6 is a partly cross-sectional view of FIG. 5, taken along the line VI-VI.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

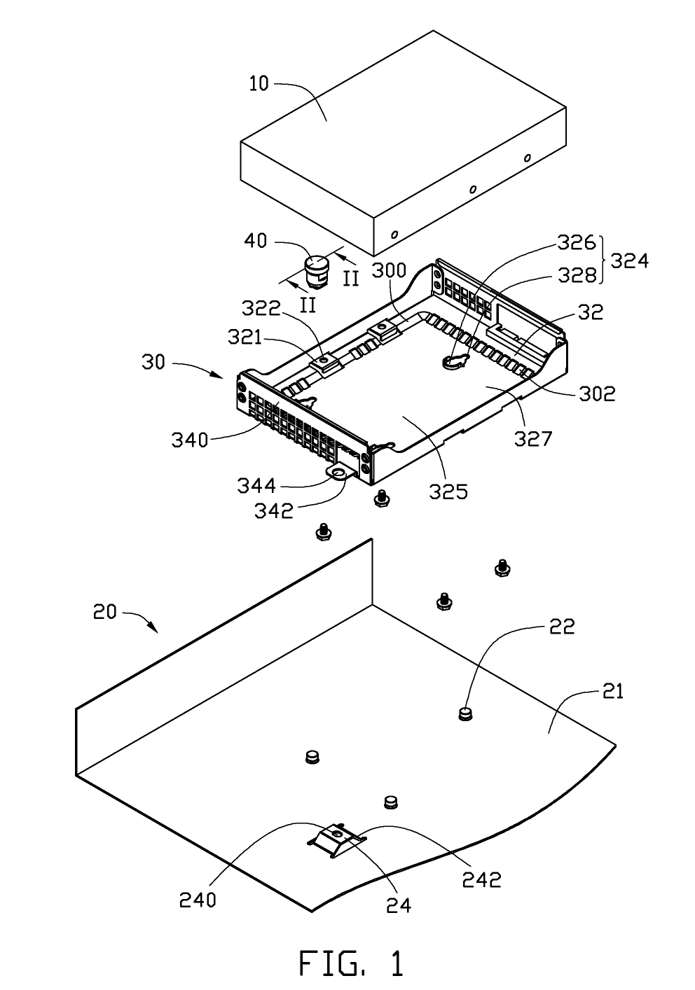

Referring to FIG. 1, an embodiment of a mounting apparatus is provided for mounting a hard disk drive (HDD) 10. The mounting apparatus includes a base board 21 of a chassis 20, a casing 30 for receiving the HDD 10, and a fixing member 40 mounted to an outer surface of the casing 30.

The base board 21 forms three substantially columnar engaging portions 22 arranged in a triangle. A bridge-shaped holding portion 24 defining a through hole 240 in a top surface protrudes up from the base board 21, in front of the engaging portions 22. The holding portion 24 includes a guiding surface 242 extending slantingly down from the top of the holding portion 24 toward the engaging portions 22.

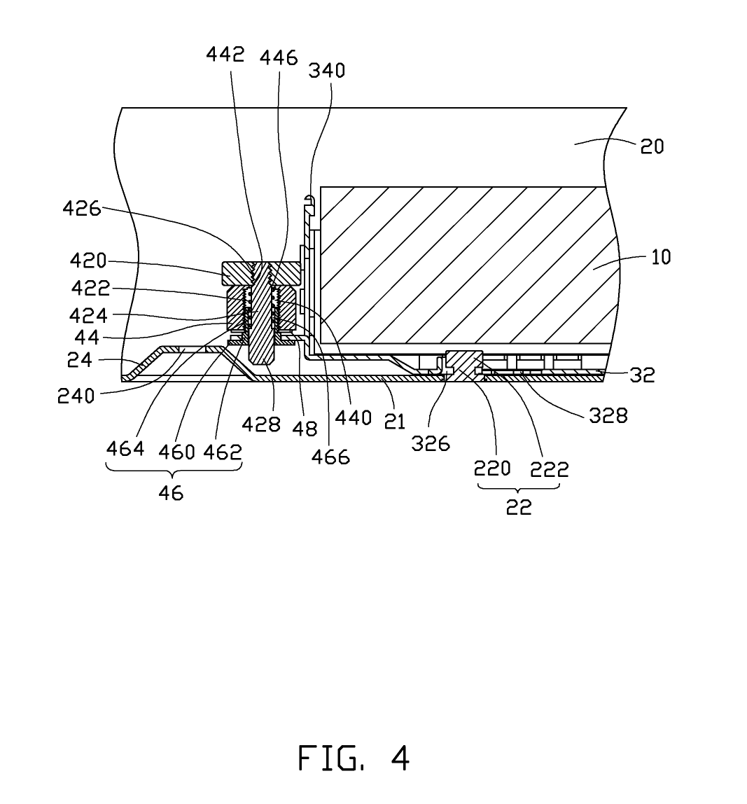

Referring to FIG. 4, each engaging portion 22 includes a neck 220 extending perpendicularly from the base board 21, and a head 222 extending from a top end of the neck 220 opposite to the base board 21. The diameter of the head 222 is greater than the diameter of the neck 220.

The casing 30 includes a bottom wall 32 and a front wall 340 extending perpendicularly from a front end of the bottom wall 32. The bottom wall 32 defines a depressed portion 325 in a center. Sidewalls 300 bounding the depressed portion 325 define a plurality of vents 302. Two supporting portions 321 each define a through hole 322 protruding from the bottom wall 32 adjacent to each opposite sidewalls 300 of the depressed portion 325. A bottom wall 327 of the depressed portion 325 defines three fixing holes 324 corresponding to the engaging portions 22. Each fixing hole 324 includes a first hole 326 adjacent to the front wall 340 and a second hole 328 communicating with the first hole 326 and positioned away from the front wall 340.

The width of the first hole 326 is greater than the width of the second hole 328. A tab 342 extends perpendicularly and out from the front wall 340, and defines a through hole 344.

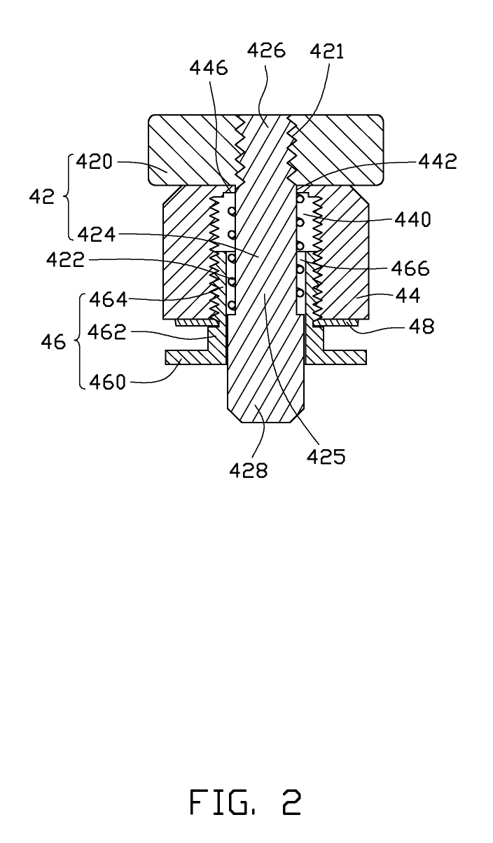

Referring to FIG. 2, in one embodiment, the fixing member is a thumbscrew. The fixing member 40 includes a movable assembly 42, a spring 422, a block 44, a blocking portion 46, and a spacer 48.

The movable assembly 42 includes a head 420 defining a threaded hole 421 and a pole 424. The pole 424 includes a middle portion 425, a threaded portion 426 connected to a first end of the middle portion 425, and an inserting portion 428 connected to a second end of the middle portion 425 opposite to the threaded portion 426. The diameter of the inserting portion 428 is greater than the diameter of the spring 422. The diameter of the spring 422 is greater than the diameter of the middle portion 425.

The block 44 defines a threaded hole 440 extending through a bottom surface of the block 44, and a through hole 442 communicating with the threaded hole 440 and extending through a top surface of the block 44 opposite to the bottom surface. The diameter of the threaded hole 440 is greater than the diameter of the through hole 442. A step 446 is formed at a junction of the through hole 442 and the threaded hole 440.

The blocking portion 46 includes a blocking piece 460, an extension portion 462 extending from a top of the blocking piece 460, and a threaded portion 464 extending from a distal end of the extension portion 462 opposite to the blocking piece 460. The blocking portion 46 defines a slot 466 extending through the blocking piece 460, the extension portion 462, and the threaded portion 464.

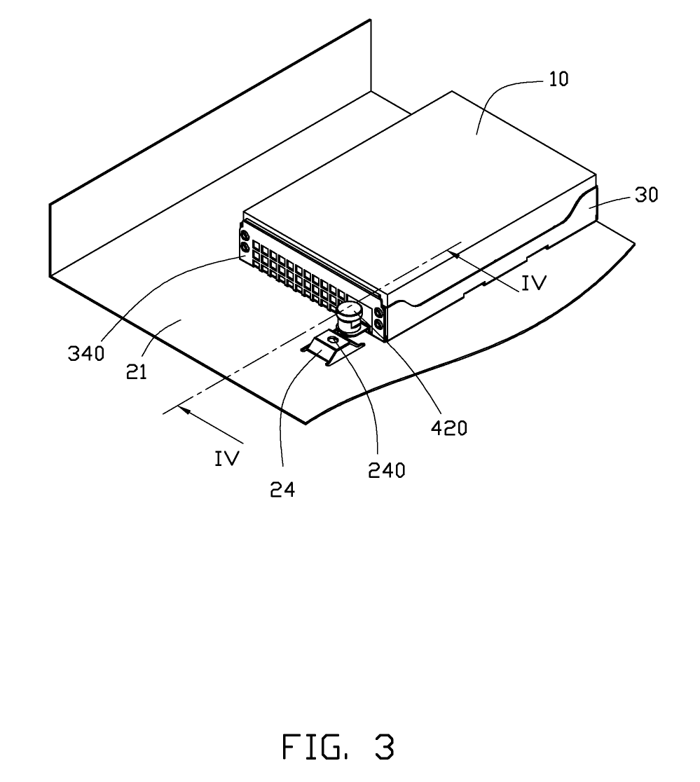

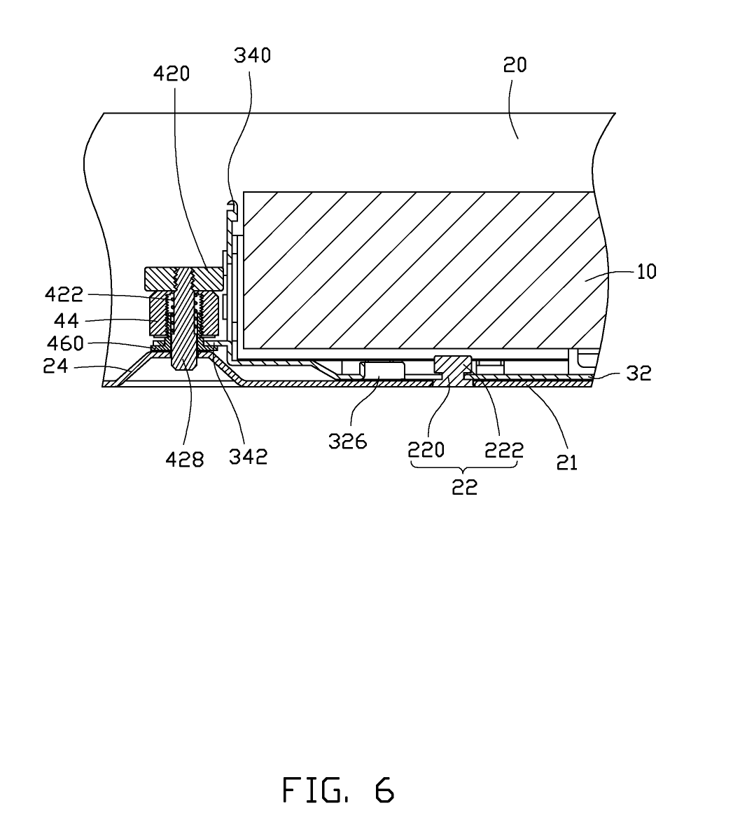

Referring to FIGS. 3 and 6, in assembly, the threaded portion 426 extends through the spring 422, the threaded hole 440, the through hole 442, and then engaged in the threaded hole 421 to fix the pole 424 to the head 420. The movable assembly 42 is movable relative to the block 44. The spring 422 is received in the slot 466 and sandwiched between the step 446 and the inserting portion 428. A distal end of the inserting portion 428 opposite to the threaded portion 426 extends out of the threaded hole 440. The threaded portion 464 extends through the through hole 344 from a bottom of the tab 342 and the spacer 48, and then engages in the threaded hole 440 until the blocking piece 460 is abutted against a bottom surface of the tab 342. The extension portion 462 is received in the through hole 344. The distal end of the inserting portion 428 extends out of the slot 466.

The HDD 10 is supported and fixed on the supporting portions 321. The casing 30 with the HDD 10 is manipulated down towards the base board 21. The engaging portions 22 extend into the first holes 326, respectively. The casing 30 is then moved towards the holding portion 24. The distal end of the inserting portion 428 abuts against the guiding surface 242 and slides toward the through hole 240. The spring 422 is deformed, and the inserting portion 428 is retracted into the slot 466 gradually while the distal end of the inserting portion 428 slides on the guiding surface 242. When the necks 220 enter the corresponding second holes 328, the inserting portion 428 is aligned with the through hole 240. The spring 422 is restored and biases the inserting portion 428 to be inserted into the through hole 240, thereby fixing the casing 30 on the base board 21. The heads 222 are blocked by the bottom wall of the depressed portion 325.

In disengaging the casing 30 from the base board 21, the head 420 is pulled away from the block 44, to disengage the inserting portion 428 from the through hole 240. The casing 30 is then readily slid away from the holding portion 24, so that the necks 220 may enter the corresponding first holes 326 again.

Because the supporting portions 321 protrude from the bottom wall 32, the bottom of the HDD 10 is never in contact with the bottom wall 327 of the depressed portion 325. The vents 302 defined in the sidewalls 300 of the depressed portion 325 can rapidly dissipate heat generated by the HDD 10.

It is believed that the present embodiments and their advantages will be understood from the foregoing description, and various changes may be made thereto without departing from the spirit and scope of the description or sacrificing all of their material advantages.

What is claimed is:

1. A mounting apparatus for mounting a hard disk drive (HDD), the mounting apparatus comprising:
a base board comprising a plurality of engaging portions and a holding portion adjacent to the engaging portions, the holding portion defining a through hole;
a casing for receiving the HDD, the casing comprising a bottom wall defining a plurality of fixing holes corresponding to the engaging portions, and a front wall extending in a substantially perpendicular manner from the bottom wall; and
a fixing member mounted to an outer surface of the front wall;
wherein each of the fixing holes comprises a first hole and a second hole having a width less than the first hole and communicating with the first hole; when mounting the casing to the base board, the engaging portions extend into the first holes of the corresponding fixing holes and the casing is moved toward the holding portion, until the fixing member is engaged in the through hole of the holding portion, and the engaging portions are engaged in the corresponding second holes.

2. The mounting apparatus of claim 1, wherein the casing further comprises a tab extending out of the front wall; the fixing member comprises a head, a spring, a pole, a block, and a blocking portion; the pole comprises a middle portion, a threaded portion extending from a first end of the middle portion to movably extend through the block and engage in the head, and an inserting portion extending from a second end of the middle portion opposite to the threaded portion; the spring is sandwiched between the inserting portion and an inner surface of a top of the block; the blocking portion comprises a blocking piece abutted against a bottom surface of the tab, and a threaded portion extending from the blocking piece to extend through the tab and engage in the block; the blocking portion defines a slot extending through the blocking piece and the threaded portion; a distal end of the inserting portion opposite to the threaded portion moveably extends out of the slot to be inserted into the through hole of the holding portion.

3. The mounting apparatus of claim 2, wherein the block defines a threaded hole extending through a bottom surface of the block to engage with the threaded portion of the blocking portion, and a through hole extending through the top of the block and communicating with the threaded hole; a diameter of the threaded hole is greater than a diameter of the through hole, thereby forming a step at a junction of the threaded hole and the through hole of the block to block an end of the spring.

4. The mounting apparatus of claim 2, wherein the holding portion is bridge-shaped, and comprises a guiding surface extending slantingly towards the engaging portions from a top to a bottom of the guiding surface; the inserting portion abuts against and slides along the guiding surface towards the through hole when the casing is moved toward the holding portion, the spring is deformed, and the inserting portion is retracted into the slot gradually, while the inserting portion slides along the guiding surface toward the through hole.

5. The mounting apparatus of claim 1, wherein the bottom wall defines a depressed portion, the depressing portion comprises a bottom wall and a plurality of sidewalls, the fixing holes are defined in the bottom wall of the depressed portion, and the sidewalls bounds the depressed portion define a plurality of vents.

6. The mounting apparatus of claim 5, wherein each of the engaging portions comprises a neck extending from the base board, and a head extending from a distal end of the neck opposite to the base board, and the head of the engaging portion is blocked by the bottom wall of the depressed portion when the neck is received in the corresponding second hole.

7. The mounting apparatus of claim 5, wherein the casing further comprises a supporting portion protruding from a junction of the bottom wall of the casing and opposite sidewalls of the depressed portion to fix and support the HDD.

8. The mounting apparatus of claim 1, wherein the casing further comprises a supporting portion protruding from opposite sides of the bottom wall to fix and support the HDD.

9. A mounting apparatus for mounting a hard disk drive (HDD), the mounting apparatus comprising:
a base board comprising a plurality of engaging portions and a holding portion adjacent to the engaging portions, the holding portion defining a first through hole; a casing for receiving the HDD, the casing comprising a bottom wall defining a plurality of fixing holes corresponding to the engaging portions, a front wall extending up from the bottom wall, and a tab extending out from the front wall and defining a second through hole; and
a thumbscrew fixed to the tab and comprising a movable assembly movably extending through the second through hole;
wherein each of the fixing holes comprises a first hole and a second hole having a width less than the first hole and communicating with the first hole; when mounting the casing to the base board, the engaging portions extend into the first holes of the corresponding fixing holes and the casing is moved toward the holding portion, until the movable assembly is engaged in the first through hole of the holding portion, and the engaging portions are engaged in the corresponding second holes.

10. The mounting apparatus of claim 9, wherein the movable assembly comprises a head, and a pole fixed to the head with a first end; the fixing member further comprises a spring fitting about the pole, a block fitting about the pole, and a blocking portion fixed to the block; the tab is sandwiched between the block and the blocking portion; the spring biases a second end of the pole to extend through the block and the blocking portion to engage in the first through hole of the holding portion.

11. The mounting apparatus of claim 10, wherein the holding portion is bridge-shaped, and comprises a guiding surface extending slantingly toward the engaging portions from a top to a bottom of the guiding surface; the second end of the pole is slidably moved on the guiding surface to deform the spring when the casing is moved toward the holding portion, until the second end of the pole engages in the first through hole of the holding portion, the spring is restored to bias the pole to move down to make the second end of the pole engage in the first through hole.

12. The mounting apparatus of claim 9, wherein the bottom wall of the casing defines a depressed portion, the depressing portion comprises a bottom wall and a plurality of sidewalls, the fixing holes are defined in the bottom wall of the depressed portion, the sidewalls bound the depressed portion and define a plurality of vents.

13. The mounting apparatus of claim 12, wherein each of the engaging portions comprises a neck extending from the base board, and a head extending from a distal end of the neck opposite to the base board, and the head is blocked by the bottom wall of the depressed portion when the neck is received in the corresponding second hole.

14. The mounting apparatus of claim 12, wherein the casing further comprises a supporting portion protruding from a junction of the bottom wall of the casing and opposite sidewalls of the depressed portion to fix and support the HDD.

15. The mounting apparatus of claim 9, wherein the casing further comprises a supporting portion protruding from opposite sides of the bottom wall to fix and support the HDD.
